(19) United States
(12) Patent Application Publication
(10) Pub. No.: US 2014/0184452 A1
(43) Pub. Date: Jul. 3, 2014

(54) ELECTRONIC DEVICE WITH INTEGRATED ANTENNA

(71) Applicant: YOTA DEVICES IPR LTD., Tortola (VG)

(72) Inventors: Jukka Hekkala, Oulu (FI); Taneli Hanni, Oulu (FI); Marko Uusitalo, Oulu (FI); Antti Saikkonen, Oulu (FI); Markku Gerlander, Oulu (FI)

(73) Assignee: YOTA DEVICES IPR LTD., Tortola (VG)

(21) Appl. No.: 14/199,264

(22) Filed: Mar. 6, 2014

Related U.S. Application Data
(63) Continuation-in-part of application No. PCT/EP2013/056705, filed on Mar. 28, 2013.

(30) Foreign Application Priority Data
Mar. 28, 2012 (GB) 1205431.8
Dec. 10, 2013 (GB) 1321806.0

(51) Int. Cl. H01Q 1/24

(52) U.S. Cl. CPC H01Q 1/241
USPC 343/702; 29/600

(57) ABSTRACT

A method and computer system for integrating an antenna radiator during the manufacturing of an electronic device comprising providing a first chassis component, providing the radiator into the first chassis and providing a second chassis component over the radiator so as to integrate it between the first and the second chassis components (e.g., using a two-shot molding technique). A chassis may be defined by at least the first and the second chassis elements. A mobile device having networking capabilities comprising an antenna comprising a radiator and a hardware module for providing a function other than the networking capabilities to the mobile device. The radiator is at least partially integrated with the hardware module. The hardware module may further integrate a connector. The hardware module may be a structural chassis of the mobile device and the chassis may further integrate additional components.

### CROSS REFERENCE TO RELATED APPLICATIONS

This non-provisional patent application is a continuation-in-part of International application entitled “LOW RADIATION DOSE RATE MOBILE PHONE”, International Application Number PCT/EP2013/056705, filed Mar. 28, 2013, which claims priority to Great Britain Patent Application GB1205431.8, filed Mar. 28, 2012, and the present application further claims priority to the prior Great Britain patent application entitled “Chassis Embedded Antennas”, Great Britain application number GB1321806.0, filed Dec. 10, 2013, all such applications in their entirety being incorporated by reference.

### TECHNICAL FIELD

The present invention relates to an electronic device and, more particularly, to an electronic device with an integrated antenna.

### BACKGROUND

Networked electronic devices are typically equipped with an antenna for enabling heir network connectivity. However, antenna integration in electronic device is typically complex and requires dedicated space.

The present invention addresses this shortcoming.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to a method for integrating a radiating antenna element during the manufacturing of an electronic device comprising providing a first chassis component of the electronic device, providing the radiating antenna element into the first chassis and, providing a second chassis component of the electronic device over the radiating antenna element so as to integrate the radiating antenna element between the first chassis component and the second chassis component.

A chassis of the electronic device may be defined by the first chassis element and the second chassis element. The chassis may further defined by the first chassis element, the second chassis element and at least a third chassis element. The second chassis component may be formed using a two-shot molding technique. The first chassis component may be made of thermoplastic material containing a metal-plastic additive and wherein providing the radiating antenna element into the first chassis is performed using a Laser Direct Structuring (LDS) technique.

The first chassis component may be on the outside of the electronic device and inserting the radiating antenna element may further comprise providing a connector to the radiating antenna element through the second chassis component towards an internal antenna controller of the electronic device. Alternatively, the second chassis component may be on the outside of the electronic device and inserting the radiating antenna element may further comprise providing a connector to the radiating antenna element through the first chassis component towards an internal antenna controller of the electronic device.

The chassis may be adapted to receive a first display area on a first face of the electronic device and a second display area on a different face of the electronic device, wherein the first display area and the second display area are of two different display technologies. The chassis may further integrate at least one additional component comprising Light Emitting Diodes and/or at least one sensor element (e.g., a touch sensor and/or a temperature sensor).

The chassis may be adapted to receive a first display area on a first face of the electronic device and a second display area on a different face of the electronic device. The first display area and the second display area may be of two different display technologies.

The second display area may be is based on bistable display technology and the electronic device may be able to function in a safe mode where only the bistable display is on.

The chassis may further integrate additional components (e.g., Light Emitting Diodes, and/or at least one sensor element. The sensor element may comprise a touch sensor and/or a temperature sensor.

The electronic device may be a full touch device and/or a full display device.

A second aspect of the present invention is directed to a mobile device having radiofrequency transmission and reception capabilities comprising an antenna, for providing the radiofrequency transmission and reception capabilities, comprising a physical radiating antenna element and a hardware module for providing a function other than the radiofrequency transmission and reception capabilities to the mobile device, the radiating antenna element being at least partially integrated with the hardware module.

The hardware module further integrates a connector.

The hardware module may be a bistable display module, wherein the bistable display module is a secondary display module of the mobile device.

The hardware module may be a structural chassis of the mobile device. The radiating antenna element may be integrated within the structural chassis of the mobile device using a two-step molding technique.

The chassis may be made of thermoplastic material containing a metal-plastic additive and wherein the radiating antenna element is integrated into the chassis using a Laser Direct Structuring (LDS) technique.

The LDS technique may further comprise providing the chassis by injection molding, activating at least one region of the chassis to be formed into the radiating antenna element by laser and coating the at least one activated region, using a conductive layer for providing the radiating antenna element.

The structural chassis may be adapted to receive a first display area on a first face of the mobile device and a second display area on a different face of the mobile device, wherein the first display area and the second display area are of two different display technologies.

The chassis may further integrate additional components comprising Light Emitting Diodes and/or at least one sensor element (e.g., a touch sensor and/or a temperature sensor).

The hardware module may be a bistable display module. The bistable display module may be a secondary display module of the mobile device. The mobile device may further provide a safe mode where only the bistable display is on.

The structural chassis may be adapted to receive a first display area on a first face of the mobile device and a second display area on a different face of the mobile device. The first display area and the second display area may be two different display technologies.

The mobile device may further be a full touch device and/or a full display device.

A third aspect of the present invention is directed to a computer system for integrating a radiating antenna element during the manufacturing of an electronic device comprising a controller module for providing a first chassis component of the electronic device, providing the radiating antenna element into the first chassis and providing a second chassis component of the electronic device over the radiating antenna element so as to integrate the radiating antenna element between the first chassis component and the second chassis component.

A chassis of the electronic device may be defined by the first chassis element and the second chassis element. The chassis may further defined by the first chassis element, the second chassis element and at least a third chassis element. The second chassis component may be formed using a two-shot molding technique. The first chassis component may be made of thermoplastic material containing a metal-plastic additive and wherein providing the radiating antenna element into the first chassis is performed using a Laser Direct Structuring (LDS) technique.

The first chassis component may be on the outside of the electronic device and inserting the radiating antenna element may further comprise providing a connector to the radiating antenna element through the second chassis component towards an internal antenna controller of the electronic device. Alternatively, the second chassis component may be on the outside of the electronic device and inserting the radiating antenna element may further comprise providing a connector to the radiating antenna element through the first chassis component towards an internal antenna controller of the electronic device.

The chassis may be adapted to receive a first display area on a first face of the electronic device and a second display area on a different face of the electronic device, wherein the first display area and the second display area are of two different display technologies. The chassis may further integrate at least one additional component comprising Light Emitting Diodes and/or at least one sensor element (e.g., a touch sensor and/or a temperature sensor).

The chassis may be adapted to receive a first display area on a first face of the electronic device and a second display area on a different face of the electronic device. The first display area and the second display area may be of two different display technologies.

The second display area may be is based on bistable display technology and the electronic device may be able to function in a safe mode where only the bistable display is on.

The chassis may further integrate additional components (e.g., Light Emitting Diodes, and/or at least one sensor element. The sensor element may comprise a touch sensor and/or a temperature sensor.

The electronic device may be a full touch device and/or a full display device.

### BRIEF DESCRIPTION OF THE DRAWINGS

Further features and exemplary advantages of the present invention will become apparent from the following detailed description, taken in conjunction with the appended drawings, in which:

FIG. 1 is a logical modular representation of an exemplary electronic device in accordance with the teachings of the present invention;

FIG. 2 is a flow chart of a first exemplary method in accordance with the teachings of the present invention;

FIG. 3 is an exploded view of an exemplary electronic device in accordance with the teachings of the present invention;

FIG. 4 is an exploded view of an exemplary electronic device in accordance with the teachings of the present invention;

FIG. 5 a perspective view of an exemplary electronic device in accordance with the teachings of the present invention; and

FIG. 6A and FIG. 6 B, referred to together as FIG. 6, are an exploded views of an exemplary electronic device in accordance with the teachings of the present invention.

### DETAILED DESCRIPTION

In a typical electronic device having a radio interface (e.g., cellular phone, tablet, laptop, wireless router or modem, etc.), the radiating antenna element may be mechanically attached to the electronic device chassis or may also be provided on a flexible film. This typical arrangement is proper for electronic devices for which space optimization is not of focus, but it becomes less efficient when many modules need to fit within a small enclosure (e.g., modern smartphone). The typical arrangement also creates potential durability issues when the radiating antenna element is prone to disconnection. In the example of a smartphone or a more complex device (e.g., dual display electronic device, device with additional display on a cover, etc.), using the typical arrangement may have a negative impact on size and weight of the electronic device.

In one aspect, the proposed technical solution enables providing an integrated radiating antenna element in an electronic device having at least one radio network interface. For instance, the radiating element may be provided between two chassis components of the electronic device, with an aim at improving durability of the radiating antenna element installation and improving space optimization in the electronic device, which may be particularly critical in dual screen electronic devices.

In some embodiments, there are provided battery/turn off notifications. Before the battery is fully discharged, a specific notification may be provided which can be shown on a second display area e.g., an EPD screen. For example: if battery charge falls to 5% charged, the electronic device and display function manager could be configured to display “Out of battery, Charge me” on the second display area e.g., a EPD screen. Or for example: if battery charge falls to 10% charged, the electronic device and display function manager could be configured to display last calls, last SMS, next events on the second display area before the electronic device turns off. In a further example, in response to a battery level falling below a defined threshold, the electronic device and display function manager could be configured to leave a text portion unchanged while an image associated with the notification is changed. In a further example, when the charge level of battery falls to a defined level, the electronic device and display function manager could be configured to display custom text and/or image(s), e.g., configurable through a user interface of the electronic device.

In some embodiments, there are provided visible marks notifications. In an example, an icon/small image appears on the second display area e.g., an EPD screen, depending on some event, wherein the event is or is not configurable by a user. In an example, an Icon/Image changes its size (e.g., size becomes bigger) depending on how a related value is changing (e.g., the notification is related to the value). For instance:

User has <500USD on his billing account, small image with US dollar appears;

User has <100USD on his billing account, image becomes bigger; or

User has <10USD, user sees big notification/big image on his second screen.

Notifications may be provided for which an input interface event is awaited or expected (e.g., touch on a touch sensitive surface). For instance, after release of a notification, a back swipe gesture may be detected on a touch sensitive surface. A pre-defined (or user-configurable) action may be associated with the notification and the gesture e.g., what the electronic devices is expected to do in response to the gesture. In another example, in response to an incoming SMS notification, if a swipe from right to the left is detected on a touch sensitive surface, an action could be that the front screen displays an SMS reply window Skilled person will readily understand that the notifications described herein may react or may not react in response to an input gesture depending on different settings/configuration without affecting the teachings of the present invention.

In some embodiments, the electronic device may be configured with one or more privacy settings to be considered when notifications are to be released to the display function manager. For instance, the electronic device may provide for a private mode and public mode. When the electronic device is set to private mode, then notifications may appear in full screen or otherwise, but only limited content may be provided thereby (e.g., icons or simple visuals that indicate a notification type or the like, where some details regarding related person(s) (to/from) are removed from the released content). Conversely, when the notification setting is set to public Mode notifications may display a photo, if available, of who it's from and some or all of its content. Swiping the touch strip may dismiss any notification.

If the phone receives several notifications at the same time then they may be stacked on top of each other on one screen, the notifications collection. The user can see what has happened since she last looked at the phone and dismiss all the notifications with a swipe, just like a single notification. Notifications are never cleared from the back screen and as long as they are treated as unhandled notifications, which means that as long as the notifications are shown in status bar on the main screen they are treated as unhandled on the back-screen as well.

Some notifications are related to time sensitive events or actions in the electronic device (e.g., real-time or time critical) such as incoming call, clock alarm and timer alarm, etc. In some embodiments, these notifications can be dismissed with a swipe (or device movement or gesture, combined or instead of the swipe) just like any other notification. The device movement, for instance, may involve moving the device in a predetermined way (e.g., drawing a circle in the air). However, in some other embodiments, the swipe and/or movement may also perform an additional action. For instance, the swipe and/or movement gesture on the mentioned notifications may result in the following actions:

Incoming Call

Swipe—mute ring tone

Long press—send busy tone—results in a missed call notification

Alarm

Swipe—snooze alarm

Long press—turn off alarm

Timer Alarm

Long press—turn off alarm

In some embodiments, notifications for which no input interface event has been detected may be maintained on the second display area (e.g., as discrete icons) on top of a background image (or wallpaper).

In some embodiments, the electronic device and display function manager could be configured to support release of various notifications, which may be further designed specifically for the second display area (e.g., taking physical limitations thereof into account). There may also be a Generic application notification, e.g., for all other 3rd party applications that can trigger notifications for release on the second display area. When the second display area is determined to be actively used, e.g., reading a book or RSS feed, then notifications may be released as a discrete overlay at the top of the second display area and may further be removed after a certain time.

In some embodiments, the electronic device and display function manager release transient full-screen notifications to the extra display, which may further be made available only in public mode. For instance, an application sends data towards the display function manager for releasing a full transient screen notification on the second display area. The full transient screen notification may be displayed by the display function manager in addition to other event notifications (e.g., for limited period of time, which may range, for instance, between 1 and 30 seconds).

For example, a full text SMS message may be received by the electronic device, which ultimately triggers release of data to the display function manager that displays a transient full screen notification. The transient full screen notifications may be dismissed, for instance, using an input interface event (e.g. a gesture such as a left/right flick/swipe at a touch sensitive area, which may further be related to the second display area). The dismissed notification may be removed by the display driver, which may further modify the displayed image by adding a smaller version of the dismissed notification on the extra display, e.g., until an additional input event indicates that it should be removed (which additional input event may be received from a touch sensitive are associated to the first display area). If the transient full screen notification is not dismissed, then the transient full screen notification may also be replaced by another event notification (e.g., half-screen, icon, bar, etc.).

In some embodiments, the electronic device and display function manager may organize the released data to be displayed on the second display area in a stack that contain ordered recent events, such as:

Missed call;

SMS message;

Calendar event; and

All other event in order of appearance;

In private mode, the electronic device and display function manager may provide 4 icons with counters to be displayed on the second display area:

Missed calls;

Missed SMS;

Missed Events; and

Other events

In public mode, the electronic device and display function manager may divide the second display area so as to provide a fixed or configurable number of sub notification areas (e.g., 3 notification slots over the wallpaper). Similar events (e.g., missed calls from one person) may always or optionally be collapsed in one item. If there is no sub area available for new notifications, old notifications may further be collapsed, e.g., by type or by indicating that “other N notifications” are available. Other event notifications also may similarly be stacked in one event notification. Stacked event notification may contain only events that have happened since last event notification was dismissed by swipe. Notifications from the second display area may be removed by the electronic device and display function manager when a corresponding notifications displayed on the first display area are cleared therefrom. Data corresponding to notification not having a corresponding notification displayed on the first display area may be prevented from being released towards the display function manager.

It may be possible to enable private mode individually for each notification for example. 3rd party application may have an ability to create custom textual and/or image content to be released to the display function manager for display on the second display area.

All notifications displayed on the first display area may have a corresponding, duplicated or reflected dataset released to the display function manager for display on the second display area.

In some embodiment, notification settings can be provided for each or for a subset of the notification types, for each mode (e.g., private mode, public mode) and/or for the second display area.

The following settings may be available:

Turn on/off notifications;

Mode selection for notifications: private/public;

The ability to disable public notifications for specific application;

Music mode on/off for wallpapers application;

Shortcut to wallpapers settings;

Back screen preinstalled applications;

Wallpaper application;

In some embodiment, notifications may be related to social networks, navigators, Voice-Over IP, messengers, e-mail, calendar, news, weather, meeting, reminders, wakeup, alarm, countdown events and events related to usage of the device as a TV remote. the notifications may also be battery-related, device-related and/or, data-related.

A hierarchy of priorities for use in deciding which information layer to present on a display area may be provided. Different notification types are different information layers—each notification type may be seen as a layer that stays on the display area until replaced by a notification of a type with higher priority.

Different software applications may be provided in the electronic device with authentication credentials for the second display area.

For instance, a clock application may be provided. Different settings may be stored in the memory module and considered at by the processor module before releasing data towards the display function manager that operates the second display area. For instance, in the clock application, it may be possible to change clock style or turn it off, select active clock collection, select clock to display from the active clock collection, preview clocks from active clock collection, which may be performed using a gesture on a touch sensitive surface located near or with the first display area or the second display area (e.g., using left/right swipe navigation at the first display area). Because of physical limitations of the second display area (e.g., refresh rate), the clock application may be prevented from shown seconds (e.g., the processor module does not authenticate the clock application if requests are too close in time or the display function manager, upon receiving the released data, ignores the data if it is too close in time). The clock application may have a preinstalled set of clock collections. New clock collections may be available for download (e.g., as separate application package files). It may be possible to remove 3rd party clock collections, while some clock collections (e.g., the preinstalled ones) may be locked and not erasable. A setting of the clock application may allow for partial or complete image color inversion for some or all of the clocks. Other settings of the clock application may allow for changing wallpaper or selecting wallpapers from different sources.

Another application that may be provided is a wallpaper application for the second display area. The wallpaper application may have a stand-alone mode and may also be used in conjunction with other applications such as the clock application. The clock application may also provide functionalities that are equivalent to the wallpaper application without being integrated therein. In the context of the clock application, wallpapers can be static (Gallery, Facebook, VKontakte, Instagram, 500 px) or dynamic (live wallpapers). The clock application may have preinstalled set of live wallpapers and may provide for installation of live wallpapers (e.g., as separate application package files). It may be possible to remove 3rd party live wallpapers while some other live wallpapers (e.g., the preinstalled ones) may be locked and not erasable.

The wallpaper application may also allow for activating a live wallpaper or select one or several sources for static wallpaper (Gallery, Facebook, VKontakte, Instagram, 500 px). A live wallpaper setting may be provided with other wallpaper settings. Static wallpapers may have 2 display modes: single and mosaic. Static wallpapers may have update interval option: 5/15/30 minutes, 1/2/4/6/12/24 hours, which may further be monitored by the processor module, e.g., using different timers. Gallery wallpaper options may have several modes: single wallpaper, multiple wallpaper and folder. Single wallpaper gallery option may present crop dialog with aspect ratio equal to back screen resolution. The list of wallpaper options may present additional information about selected options (e.g., single/multiple/folder for Gallery item). The memory module may further store user credentials for external providers (e.g., Facebook, VKontakte, Instagram and 500 px services) so that the wallpaper application may access these providers as a wallpaper source of wallpaper collection.

For Facebook/VKontakte wallpaper sources, different settings or mode may be provided: single photo, multiple photos, album and user's news feed. Single and multiple photos may be selected from user's albums.

For Instagram wallpaper source, different settings or mode may be provided: single photo, my stream, favorites, friends, tag.

For 500 px wallpaper source, different settings or mode may be provided: photos, stories, flow, favorites, popular, editor's choice, upcoming, fresh.

The wallpaper application may include a least 3 types of preloaded live wallpapers: changing type, weather, all about me. Changing types live wallpaper may be fractal/image/texture generation based on some rules. Wallpaper may use phone system information (e.g., received calls/messages) as an input for selecting/preparing/generating data to be displayed.

Weather live wallpaper may use location information to provide weather information. A setting may be provided to choose one or several locations manually. A touch input (e.g., left/right swipe on a touch sensitive surface) may cause the weather live wallpaper to switch between several locations. Location may contain background photo based on current weather/city.

All about me live wallpaper may provide social user's information from different social networks: Facebook, VKontakte, twitter. Wallpaper may display public replies.

Another example of application is a todo application, for which settings may be adjusted from a first display area application icon. The todo application may allow for creating several todo lists from the first display area, selecting a todo list from the first display area and sending an instruction for the selected todo list to be displayed on the second display area (e.g., the processor module receives a request that comprises the todo list and authenticates the todo application before releasing the data towards the display driver). The todo application may be limited to displaying only one todo list at one time. Other settings of the todo application may allow for selecting a todo list theme for each todo list and adding/editing/removing items to the list. Items count in the todo list may be limited to N items.

Another example of application is a standalone weather application, for which settings may be adjusted from a first display area application icon. The weather application may detect user location and suggest city at start up. Current location may be available as separate option and it may not be possible to delete the option. The weather application may allow for adding several cities using text search with suggestions and may also allow for switching between two navigation modes: one city and multiple cities. In one city mode user may select only one city and switch between modes: day>week; day>next day; day>next week. Mode defines left/right swipes external touch sequence. In multiple cities mode user may select several cities and switch between modes: day; week. Mode defines left/right swipes external touch sequence.

Another example of application is a calendar application, for which settings may be adjusted from a first display area application icon. The electronic device may be associated to user account(s) for which account calendar information is available. Local calendar information may also be available. When no account calendar information is found, the calendar application may provide a specific interactive workflow (e.g., “add calendar” on the first display area) for opening an account or for associating an existing account with the application/with the electronic device. A put to back button or option in the calendar application may be available only when calendar information is found.

The “add calendar” workflow may allow for choosing one calendar from a list of available calendars at the electronic device (local information, creating an account or associated the calendar to one or more accounts). The calendar application may also allow for choosing one of the following options for the second display area: left/right navigation: event>next event> . . . ; day>next day> . . . ; week>next week> . . . ; event>day>week.

Another example of application is an interactive reminder application, for which settings may be adjusted from a first display area application icon. The settings of the interactive reminder application may include a predefined list of interactive reminder templates and may also allow for changing repeating options. The interactive reminder application may not be available as stand-alone application towards the second display area, but may be available for other application to use (e.g., authentication credentials for the interactive reminder application indicate some limitations). For instance, the interactive reminder application may only be allowed to request display of full screen notifications.

Another example of application is a countdown application, for which settings may be adjusted from a first display area application icon. Settings may be provided for choosing from a predefined list of commitment templates, setting a date (e.g., starting from date or ending date), choosing from several commitments and switching between them (e.g., with an touch input gesture such as a left/right swipe near or at the second display area), setting custom commitment (change text and image), changing reminder options for the each commitment (for ending date), etc.

Another example of application is a put-to-back application, for which settings may be adjusted from a first display area application icon. A put-to-back screenshot history application may further be available separately. A put-to-back gesture may be available on the electronic device to take a screenshot and place it to the second display area without any additional action (e.g., a double finger down swipe on a touch sensitive surface over the first display area). For instance, the screenshot be sent or referenced in a request from the put-to-back application to the processor module, which would authenticate the put-to-back application before releasing request (e.g., the screenshot) towards the display function manager for display on the second display area. The put-to-back application may be available in the recent applications list from the memory module. It may be possible to capture up to ten screenshots, store them in the memory module and manage them (e.g., select a screenshot, delete screenshots from history, etc.) via the put-to-back application or put-to-back screenshot history application. An input interface event (e.g., a left/right swipe over a touch sensitive area near or over the main or the second display area) may switch between put-to-back screenshots from the history. When the put-to-back history is empty, a tutorial may be displayed on the first display area. A put-to-back button, otherwise available from an action bar displayed on the first display area, may be disabled during the tutorial.

Another example of application is a send-something application, for which settings may be adjusted from a first display area application icon. A “local” send-something application is able to pair with one or more “remote” send-something applications executing on remote electronic devices having a second display area. Once paired, the local send-something application may send data to one or more remote send-something applications for display on the remote electronic devices' second display area. The send-something application may allow for choosing from a predefined list of send-something templates, editing text in each template, adding his/her own image, choosing several send-something screens and switch therebetween (e.g., with a touch input from a touch sensitive surface near or at the second display area such as a left/right swipe at the back screen), adding one or more remote electronic devices and sending send-something data directly to at least one of them.

Another example of application is a daily quotes application, for which settings may be adjusted from a first display area application icon. The daily quotes application allows for selecting one or several quotes sources (e.g., famous people, jokes, etc.), selecting a refresh interval, switch between quotes (e.g., using a touch event from a touch sensitive surface).

Another example of application is a birthday application, for which settings may be adjusted from a first display area application icon. The birthday application may allow for selecting birthdays to remind from several sources (e.g., contacts, Facebook, VKontakte), adding personal birthday's list to remind, viewing birthdays from all sources in one list, etc. The birthday application may have a stand-alone mode and may also be used in conjunction with other applications such as the calendar application. A notification time setting may be available in the birthday application (e.g., previous day reminder time, birthday day reminder time, etc.).

Another example of application is a Rich Site Summary (often dubbed “Really Simple Syndication”)—RSS reader application, for which settings may be adjusted from a first display area application icon. The RSS reader application may allow for selecting one or more sources from a predefined RSS sources list (e.g., from remote providers and/or from local repository stored in the memory module). Sources setup screen may be displayed only at first start up. The RSS reader application may allow for requesting, from the first display area, release of a specific content from the memory module to the second display area. The RSS reader application may allow adding custom RSS link to the list and removing custom RSS links from the list. The RSS reader application content to be displayed from the memory module on the second display area may comprise display title, source name and time. When the RSS application setup is complete, the application icon may display the titles from the list released to the second display area. User may be able to select an interesting title and view full link in a web browser.

Another example of application is a timer application, for which settings may be adjusted from a first display area application icon. The timer application may allow for setting up a timer from the first display area by requesting release of an initial content corresponding to the timer towards the display driver (the request is authenticated by the processor module before being released towards the display driver). Once the second display area displays the timer, the timer application may allow for starting the timer and stopping the timer (e.g., from one or more input from a touch sensitive surface near or at the second display area), resetting the timer (e.g., from one or more input from a touch sensitive surface near or at the first display area) and enabling countdown timer (for hours, minutes and seconds). When the timer application is started, it may request release of subsequent content corresponding to the (changing) timer towards the display driver.

The processor module may authenticate any of the exemplary applications (e.g., the timer application) once for a period of time (e.g., 20 seconds) or until another application requests release of data towards the display driver. During the period of time for which the application remains authenticated, following requests may be released towards the display driver without further authentication. Once the period of time expires, the processor may have to re-authenticate the request. When another application requests release of data (e.g., during the period of time), the processor may pause the previously authenticated application and cause the display driver to ignore all data that it may receive therefrom. A state associated with the previously authenticated application may be stored in the memory module for future use. The processor may then authenticate the new request from the other application (e.g., if the other application has a higher priority or if the data to be released has a higher priority). Once the new request from the other application is completed, the processor module may restore the previously stored state from the memory module and re-authenticate the application for release of data towards the display driver.

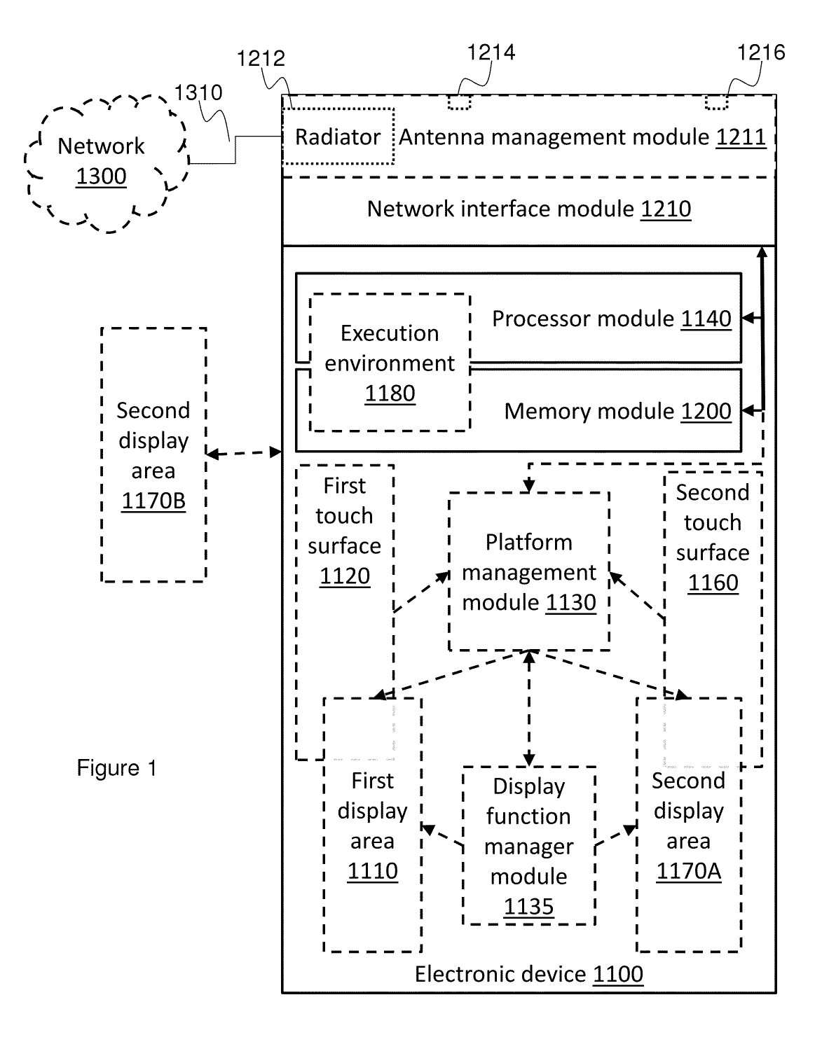

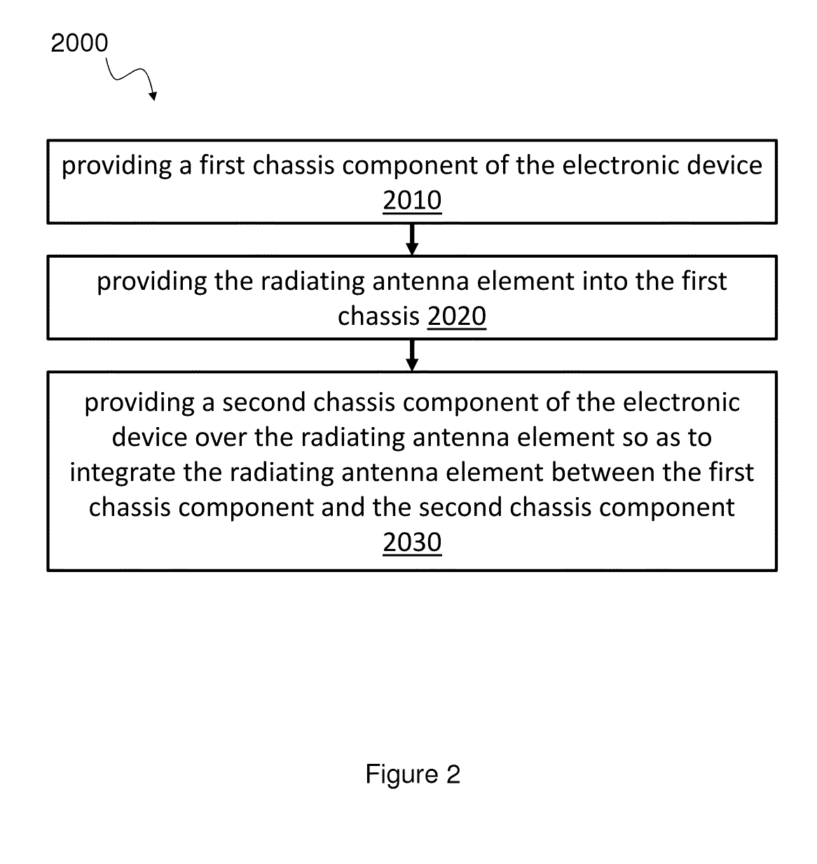

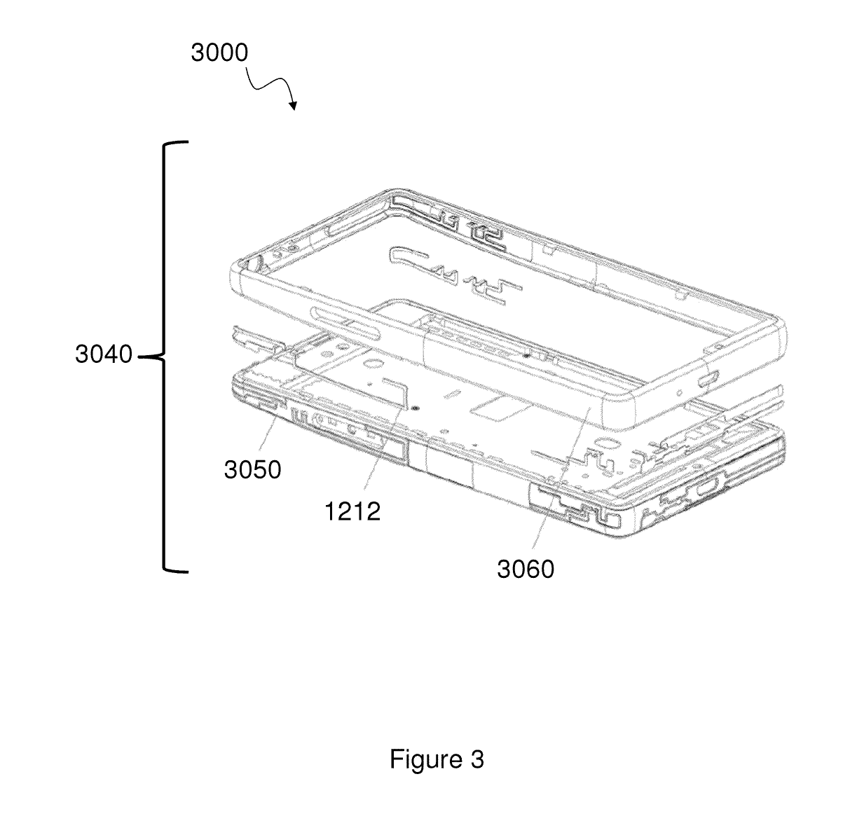

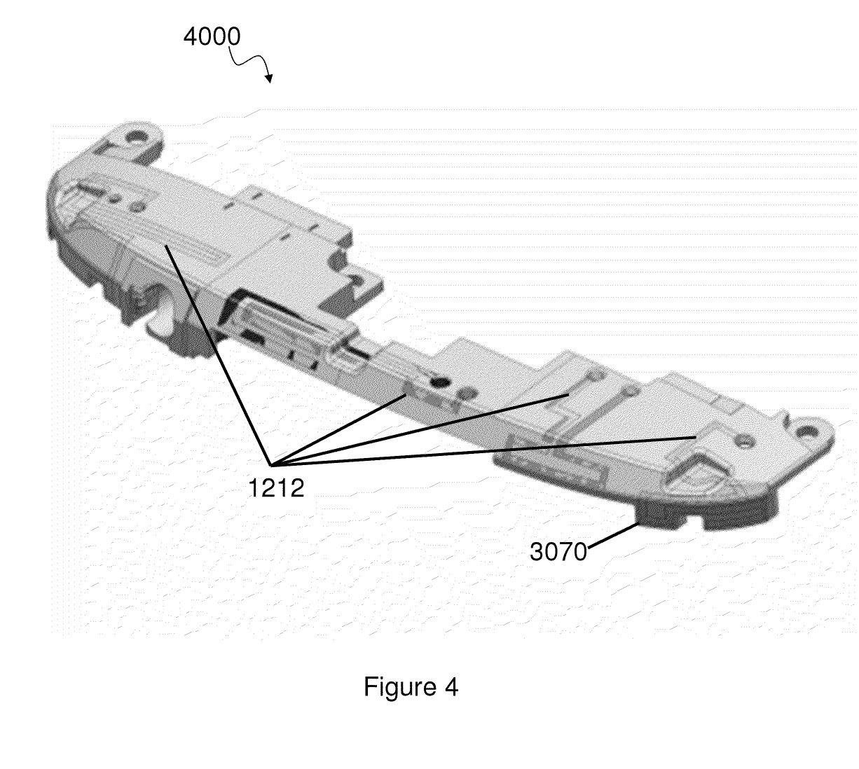

Reference is now concurrently made to the FIGS. 1 to 6. FIG. 1 shows a logical modular representation of an exemplary electronic device 1100 in accordance with the teachings of the present invention. FIG. 2 shows a flow chart of an exemplary method 2000 in the exemplary electronic device 1100, in accordance with the teachings of the present invention. FIGS. 3 and 4 show exemplary physical modular views of the exemplary electronic device 1100, in accordance with the teachings of the present invention. The electronic device 1100 comprises a processor module 1140, a memory module 1200, a network interface module 1210 that may be used to connect to a network 1300, an antenna management module 1211 (provided with the network interface module 1210 or separately) and one or more radiating antenna elements 1212 (depicted together with a radio interface of the antenna management module 1211/network interface module 1210). The network interface module 1210 may comprise different interfaces 1214, 1216 used to connect to the network 1300 or to other devices (not shown). The different interfaces 1212, 1214, 1216 may, for instance, be used to connect to a Wide Area Network (WAN) (e.g., cellular network using LTE, 3G and/or WiMax technologies), a Local Area Network (LAN) or Wireless LAN (e.g., using 802.1111a/b/g/n/ac), a local device (e.g., a Universal Serial Bus (USB) interface). The network interface module comprises at least one wireless network interface providing a wireless connection 1310 via the radiator 1212 (i.e., providing radiofrequency transmission and reception capabilities to the electronic device 1100). More than one wireless interface may be present in the electronic device 1100 and may use the same radiator 1212, shared or dedicated radiators (as further exemplified on FIG. 4).

The electronic device 1100 may also comprise, depending on the selected embodiments, a first display area 1110, a touch sensitive surface module 1120, a platform management module 1130, a display function manager module 1135, a second display area 1170A or 1170B (the two alternatives being referred to as 1170), a second touch sensitive surface 1160, a storage module (not shown) and an execution environment and OS framework 1180. Physical and logical connections between the different modules 1110-1211 are not necessarily shown on the logical representation of FIG. 1 to ensure clarity and readability of the figure. Skilled persons will readily understand that various electrical connections are required for proper function of the electronic device 1100, but those do not affect the teachings of the present invention Likewise, some modules are not shown or shown as optional in the context of the present invention while they may be required for the proper function of the electronic device 1100 (e.g., a power module, battery (not shown) or the memory module 1200).

The second display area 1170 may be provided within the electronic device 1100 (1170A) or on an accessory 1400 (1170B) attached to the electronic device 1100. The second display area 1170 is driven through the display function manager module 1135 that ultimately runs on the processor module 1140, even when connected as the accessory 1400. The second display area may be able to function in a safe mode where only the bistable display is on.

In some embodiment, a dissipation sheet (not shown) may be positioned between electronic components and the second display area for dissipating heat. At least one temperature measurement related to the second display area 1170 may be obtained, e.g., from a temperature measurement module (not shown).

FIG. 2 provides an exemplary method 2000 for integrating the radiator (or radiating antenna element) 1212 during the manufacturing of at least the chassis 3040 of the electronic device 1100. The method 2000 comprises providing a first chassis component 3050 of the electronic device 1100 (2010) and providing the radiating antenna element 1212 into the first chassis component 3050 (2020). In one embodiment, the step 2020 of providing the radiating antenna element 1212 into the first chassis 3050 may be performed by inserting at least one hardware radiator 1212 into the first chassis component 3050. In another embodiment, the step 2020 of providing the radiating antenna element 1212 into the first chassis 3050 may be performed by inserting at least one hardware radiator 1212 into the second chassis component 3060. In another embodiment, the step 2020 of providing the radiating antenna element 1212 into the first chassis 3050 may involve providing the first chassis component 3050, or a chassis element of the first chassis component, in a thermoplastic material that also contains a metal-plastic additive is activated by means of a Laser Direct Structuring (LDS) technique. Then, one or more antenna patterns are activated by laser. A coating process over the activated pattern, using conductive layers, then provides the radiator 1212. In yet another embodiment, more than one radiator may be provided as a hardware radiator and/or laser-activated radiator.

The first and/or second chassis component 3050 and 3060 may be provided, e.g., in plastic (injection molding or any other suitable technique), in metal (insulated in some relevant sections) or any mix of plastic and metal. The component material may be identical or different for the different components of the chassis 3040.

The method 2000 also comprises providing a second chassis component 3060 of the electronic device over the radiating antenna element 1212 so as to integrate the radiating antenna element 1212 between the first chassis component 3050 and the second chassis component 3060 (2030). The chassis 3040 of the electronic device 1100 is therefore defined by at least the first chassis element 3050 and second chassis element 3060. The chassis 3040 may thus be manufactured using a two-shot molding technique. The radiator 1212 may be provided with anyone of the chassis components 3050 and/or 3060 (e.g., by physical insertion or Laser Direct Structure (LDS) technique as discussed below) before the second shot of the two-shot process.

The two-shot molding technique or two-shot molding process involves forming a final injection-molded plastic piece using more than one injection. The two or more injections could be performed at about the same time or could be performed sequentially. In the present context, at least two of the injections are delayed in time to allow integration of at least one additional component between two layers of the plastic piece. While it is referred herein as a two-shot process, more than two injections could be performed without affecting the teachings of the present invention. For instance, it would be possible to integrate different components between different injection layers of the final injection-molded plastic piece. Furthermore, a first element could be made by at least partially simultaneous injections while a second element is provided by a delayed injection after integration of at least one component in the first element. In some embodiments, one or more components may be integrated in one element during the injection (e.g., previously positioned in the mold or positioned during the injection) in order to avoid or at least minimize the delay between injections.

In the example of FIG. 2, only the first and second elements 3050 and 3060 form the chassis 3040. Additional chassis elements (not shown) may be provided in order to provide the complete chassis 3040. For instance the second chassis component 3060 may be formed by two or more subcomponents (not shown).

In the example of FIG. 2, the second chassis component 3060 is on the outside of the electronic device 1100 and inserting the radiating antenna element 1212 also comprises providing a connector to the radiating antenna element 1212 through the first chassis component 3050 towards an internal antenna controller of the electronic device 1100. Skilled person will readily understand that the first chassis component 3050 may also be on the outside of the electronic device 1100 that inserting the radiating antenna element 1212 may further comprise providing a connector to the radiating antenna element 1212 through the second chassis component 3060 towards the internal antenna controller of the electronic device 1100. In addition, the one or more radiators 1212, if at least one is provided by the LDS technique, may be provided in only the first chassis component 3050 (or chassis element thereof), only the second chassis component 3060 (or chassis element thereof) or in both the first chassis component 3050 and the second chassis component 3060 (and/or any other additional chassis component of the chassis 3040).

In some embodiments, the one or more radiators 1212 obtained using the LDS technique are not integrated into the structural chassis, but are provided as chassis element, which will be screwed or otherwise solidarized with the structural chassis. While the structural chassis could integrate LDS radiators (e.g., using the two-shot molding process), it may be suboptimal as the LDS-activated thermoplastic is typically more difficult to paint and more vulnerable to drops. It may also prove less versatile during phone assembly, more costly and logistically more difficult to supply.

The chassis 3040 may also be adapted to receive a first display area on a first face of the electronic device and a second display area on a different face of the electronic device 1100. The first display area and the second display area may be based on two different display technologies. As skilled reader will readily recognize, the chassis 3040 may further integrate additional components (e.g., Light Emitting Diodes (LEDs for notification or camera flash/lamp)), at least one sensor element (touch sensor and/or a temperature sensor), proximity (e.g., infrared) sensor, light sensor, etc.). The additional components may be integrated at the same time as the radiator 1212 (e.g., substantially simultaneously or sequentially in the two-shot process) or using a conventional process (e.g., after the two-shot process).

Skilled persons will readily appreciate that the different steps in the method 2000 may involve automated and/or manual steps. A computer system may further be used for automated steps, which may involve a variety of software processes, which does not affect the teachings of the present invention.

On the examples of FIGS. 3, 4 and 6, at least one antenna of the electronic device 1100 provides radiofrequency transmission and reception capabilities via the physical radiating antenna element 1212. In the example of FIGS. 3 and 4, electronic device and mobile device are used interchangeably. A hardware module, that has a function other than the radiofrequency transmission and reception capabilities, at least partially integrates the radiating antenna element. The hardware module may also integrate, in addition to the radiator 1212, a connector 6010 of the device 1100. The connector 6010 may be a 3.5 mm audio/video connector.

The hardware module may also be a bistable display module. The bistable display module may be a secondary display module 1170. The secondary display module 1170 may always be on (i.e., data is visible thereon without interruption unless actively shutdown).

The hardware module may be a structural chassis or chassis component (3050, 3060 and/or 3070) of the mobile device 1110. The radiating antenna element 1212 may then be integrated within the structural chassis of the mobile device using a two-step molding technique.

The structural chassis may be adapted to receive a first display area on a first face of the mobile device and a second display area on a different face of the mobile device. The first display area and the second display area may be of two different display technologies. The structural chassis may also further integrate additional components (e.g., Light Emitting Diodes (LEDs), at least one sensor element (e.g., a touch sensor and/or a temperature sensor), etc.).

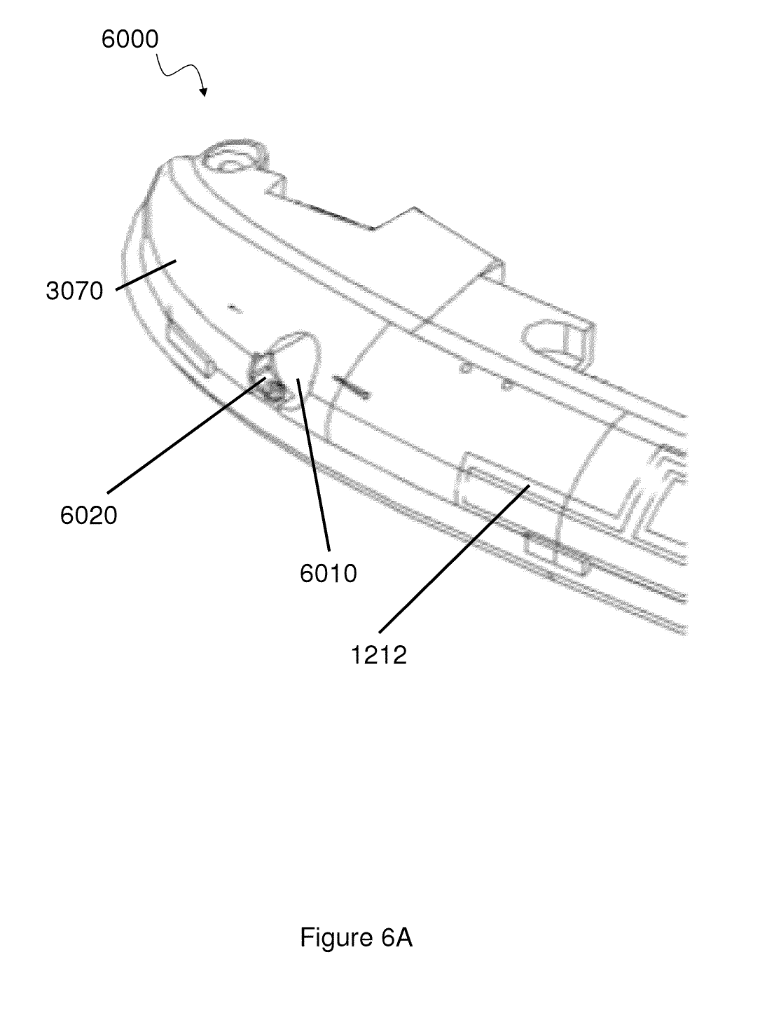

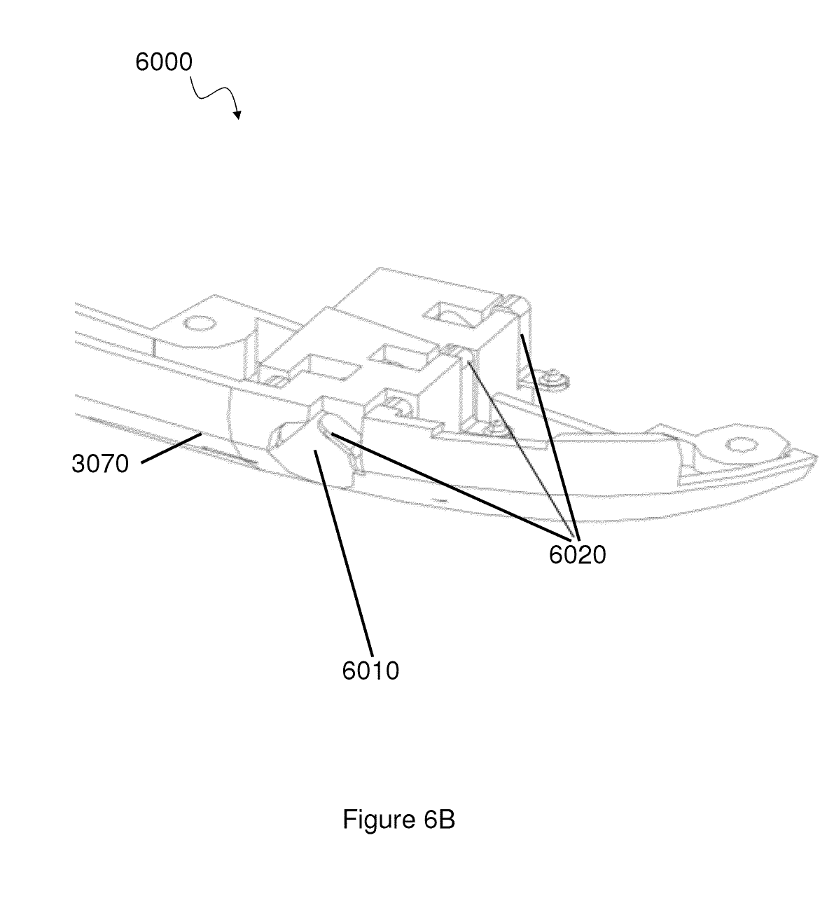

In the example depicted on FIG. 4 and FIG. 6, the radiator 1212 is provided by the chassis component 3070 by a Laser Direct Structuring (LDS) where a thermoplastic material that also contains a metal-plastic additive is activated by means of a laser. More specifically, the chassis component 3070 (also referred to as antenna carrier) may first be provided by injection molding. Then, one or more antenna patterns are activated by laser. A coating process over the activated pattern, using conductive layers, then provides the radiator 1212. As previously mentioned, the LDS technique may be performed in the context of the two-shot molding process on one or more of the components, which is especially useful if a mix of LDS and physical radiators 1212 are used and/or if other components (such as LEDs and/or sensors) are to be integrated in the two-shot molding process in addition to one or more LDS radiators 1212.

In more details, one exemplary LDS technique comprises injection molding the components to be laser structured, which may typically be performed using 1-shot injection molding of commercially available doped thermoplastic, but may also be performed using 2-shot molding. The doped thermoplastic comprises a laser-activatable additive. The additive is activated by the laser beam. More specifically, the laser beam triggers a physical-chemical reaction that allows the formation of metallic nuclei. The metallic nuclei may then act as a catalyst that allows copper plating to bind therewith. The laser may also create surface roughness, which may also be useful to firmly anchor the copper layer during metallization. The metallization of the components starts may require a preliminary cleaning step. The components may then be submerged in electro-less copper baths that would allow an additive build-up of the activated regions (typically a 5-8 μm). The plating of the activated regions then follow (e.g., with current-less nickel and flash gold). Application-specific coatings such as Sn, Ag, Pd/Au, OSP can also be created.

On the optional example depicted on FIG. 6, the chassis component 3070 also integrates an audio/video connector 6010 into the same material. The AV connector 6010 could be a 3.5 mm connector. In the depicted example, connector springs 6020 of the connector 6010 are provided in the chassis component 3070 (e.g., by press fitting). The connector springs 6020 provide an interface towards an internal module of the electronic device 1100 responsible for management of the AV connector. When integrating the AV connector 6010 in the chassis component 3070, the design of the connector 6010 has to be redone when the design of the chassis 3040 changes, which is avoided if a typical stand-alone AV connector (not shown) was integrated in the electronic device 1100. However, the AV connector 6010 allows adjusting the design to specific characteristics of the chassis 3040/the electronic device 1100 (e.g., exemplary advantages may include thinner structure of device 1100, better integration into an external surface shape of the device 110 providing better visual, better water resistance, more robust product structure, etc.). The integration of the AV connector 6010 is exemplified into the chassis component 3070 that also integrates one or more radiators 1212 through the LDS technique, which may be helpful if limiting the number of steps and/or components is as objective Skilled persons will note that that the integration of the connector 6010 could be achieved into other components of the chassis 3040.

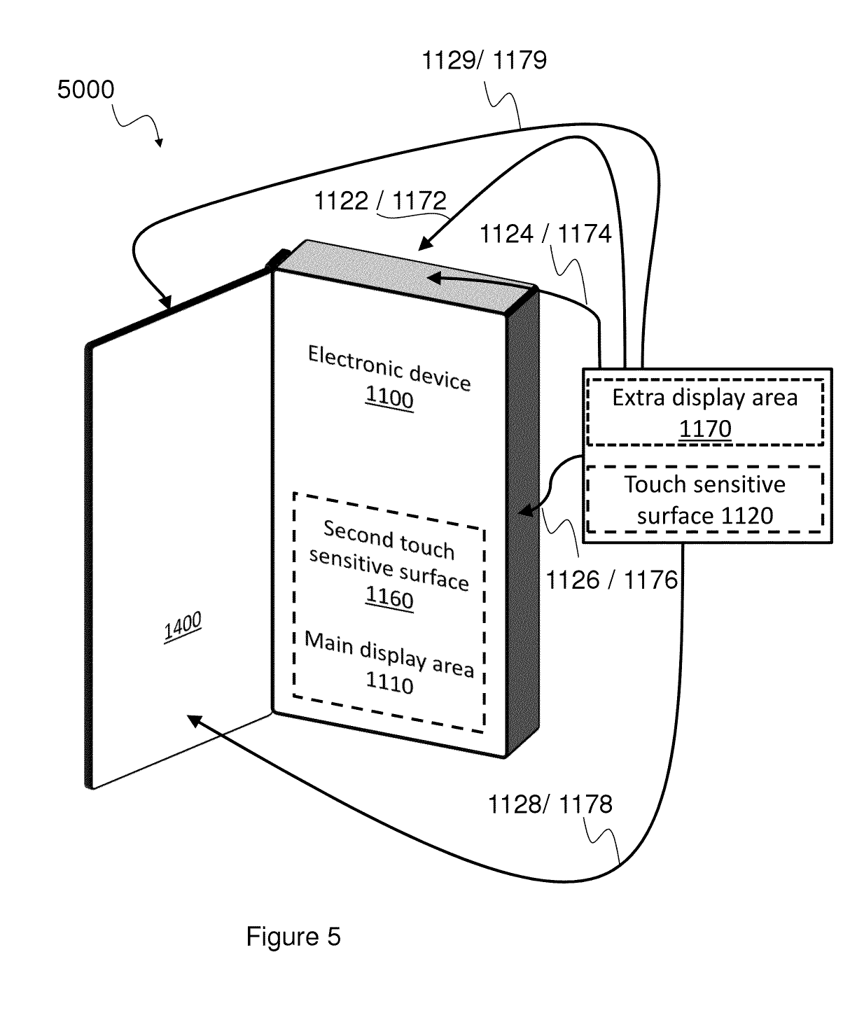

On FIG. 5, the first display area 1110 of the electronic device 1100 is shown on what will be referred to as the front face of the electronic device 1100. In the example of FIG. 5, the second display area 1170 may be located on another face of the electronic device 1100, i.e., shown as being located on a back face of the electronic device 1100 (1172), on a top (and/or bottom) face of the electronic device 1100 (1174) or on at least one lateral face of the electronic device 1100 (1176). Only the top face 1172 and one lateral face 1176 are shown because of the perspective view of FIG. 5, but skilled person will readily understand that the bottom face and/or other lateral face could be used as well. While the electronic device 1100 as shown on FIG. 5 is a typical rectangular prism (or bar form factor device), skilled persons will readily acknowledge that the teachings of the present invention are applicable to various devices having different configurations. Notably, the edges between the top and/or lateral and/or back faces may be so rounded as to define a single rounded face. Pushed to the limit, the electronic device 1100 could be a complete or partial sphere where the different surfaces are defined by the view angle of a typical user, e.g., the first face being the visible one and the hidden face being the second one. The second display area 1170, as defined with reference to the example shown on FIG. 5, may thus be overlapping completely or partially over 1172, 1174 and 1176 as shown on FIG. 5. In addition, the edge between the front face and the other faces may also be rounded. However, at least a significant portion of the second display area 1170 is not overlapping with the first display area 1110. More specifically, there exist at least a portion of the second display area 1170 that can be operated by a device driver separately from the first display area 1110. In the example of FIG. 5, the second display area 1170 may also be located on the accessory 1400 connected to the electronic device 1100, i.e., shown as being located on a front face of the accessory 1400 (1178), or a back face of the accessory 1400 (1179).

There could also be a single (1120), multiple touch surfaces (1120/1160) or any number of separate or common touch sensitive surfaces 1122, 1124, 1126, 1128, 1129 (e.g., there could be at least as many overlapping/common or independent touch sensitive surfaces as there are faces to the electronic device 1100 and the accessory 1400). As such, the electronic device 1100 may be a full touch device and/or a full display device. More specifically, the electronic device 1100 may be a full display device with a first display covering a portion of the device and a second (e.g., EPD) display covering the rest of the electronic device 1100 (e.g., except the various expected plugs, holes or other connection). A single touch sensitive surface (i.e., with a single touch controller) may additionally overlap the first and second displays thereby providing a full touch and full display device. As mentioned previously, the secondary display module 1170 may always be on (i.e., data is visible thereon without interruption unless actively shutdown).

The electronic device 1100 could take different shapes, such as a bar form device, a flip device or a spherical device without affecting the teachings of the present invention Skilled person will also readily understand that the electronic device 1100 could be a smartphone, tablet pc, reader, etc. without affecting the teachings of the invention.

In the example shown, an image is displayed (or has been displayed and is now shown) on the first display area 1110 on the first (i.e., front) face. The image may be fixed (as exemplified on FIG. 5) or may be dynamic (e.g., an animated image or a video) or could also be touch-interactive (e.g., a menu, a device main or home screen, an icon map or any other image generated by a software or hardware component of the display device 1100). The first display area 1110 may alternatively be blank or turned-off (e.g., the display device 1100 is off or is shut down, is in sleep mode or a screen that holds the first display area is turned off).

The processor module 1140 may represent a single processor with one or more processor cores or an array of processors, each comprising one or more processor cores. The memory module 1200 may comprise various types of memory (different standardized or kinds of Random Access Memory (RAM) modules, memory cards, Read-Only Memory (ROM) modules, programmable ROM, etc.). The storage module 1190 may represent one or more logical or physical hard disk drive (HDD) or solid-state drive (SSD) (or an array thereof) or any equivalent storage technology. The network interface module 1210 represents at least one physical interface that can be used to communicate with other nodes. The network interface module 1210 may be made visible to the other modules of the network node 1100 through one or more logical interfaces. The actual stacks of protocols used by the physical network interface(s) and/or logical network interface(s) of the network interface module 1210 do not affect the teachings of the present invention. The electronic device 1100 may further use encryption while some or all of its data exchanges. The variants of processor module 1140, memory module 1200, network interface module 1210 and storage module 1190 usable in the context of the present invention will be readily apparent to persons skilled in the art. Likewise, even though explicit mentions of the memory module 1200 and/or the processor module 1140 are not made throughout the description of the present examples, persons skilled in the art will readily recognize that such modules are used in conjunction with other modules of the network node 1100 to perform routine as well as innovative steps related to the present invention. Some of the different modules described herein may also be located remotely (e.g., on another device, a remote server or remote storage). Various network links may be implicitly or explicitly used in the context of the present invention, e.g., between devices and/or network equipments. Any number of routers and/or access point (not shown) may be present on such links, which may further pass through the Internet (e.g., over a virtual private network (VPN) connection). Links may further be wireless (cellular network, W-LAN, Bluetooth™, etc.) or wired link (e.g., Ethernet, coaxial cable, an optical fiber, etc.).

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for integrating a radiating antenna element during the manufacturing of an electronic device comprising:
providing a first chassis component of the electronic device;
providing the radiating antenna element into the first chassis component; and
providing a second chassis component of the electronic device over the radiating antenna element so as to integrate the radiating antenna element between the first chassis component and the second chassis component.

2. The method of claim 1, wherein a chassis of the electronic device is defined by the first chassis element and the second chassis element.

3. The method of claim 1, wherein a chassis of the electronic device is defined by the first chassis element, the second chassis element and at least a third chassis element.

4. The method of claim 1, wherein providing the second chassis component is performed using a two-shot molding technique.

5. The method of claim 1, wherein providing the radiating antenna element into the first chassis component comprises integrating a chassis element made with thermoplastic material containing a metal-plastic additive and wherein the radiating antenna element is obtained using a Laser Direct Structuring (LDS) technique.

6. The method of claim 1, wherein the first chassis component is on the outside of the electronic device and inserting the radiating antenna element further comprises providing a connector to the radiating antenna element through the second chassis component towards an internal antenna controller of the electronic device or wherein the second chassis component is on the outside of the electronic device and inserting the radiating antenna element further comprises providing a connector to the radiating antenna element through the first chassis component towards an internal antenna controller of the electronic device.

7. The method of claim 1, wherein the chassis is adapted to receive a first display area on a first face of the electronic device and a second display area on a different face of the electronic device, wherein the first display area and the second display area are of two different display technologies.

8. The method of claim 1, wherein the chassis further integrates at least one additional component comprising Light Emitting Diodes and/or at least one sensor element.

9. The method of claim 8, wherein the at least sensor element comprises a touch sensor and/or a temperature sensor.

10. A mobile device having radiofrequency transmission and reception capabilities comprising:
an antenna, for providing the radiofrequency transmission and reception capabilities, comprising a physical radiating antenna element; and
a hardware module for providing a function other than the radiofrequency transmission and reception capabilities to the mobile device, the radiating antenna element being at least partially integrated with the hardware module.

11. The mobile device of claim 10, wherein the hardware module further integrates a connector.

12. The mobile device of claim 11, wherein the hardware module is a bistable display module, wherein the bistable display module is a secondary display module of the mobile device.

13. The mobile device of claim 11, wherein the hardware module is a chassis element of the mobile device.

14. The mobile device of claim 13, wherein the radiating antenna element is integrated within the chassis element of the mobile device using a two-step molding technique, wherein the chassis element is a structural chassis element.

15. The mobile device of claim 13, wherein the chassis element is made of thermoplastic material containing a metal-plastic additive and wherein the radiating antenna element is integrated into the chassis using a Laser Direct Structuring (LDS) technique.

16. The mobile device of claim 15, wherein the LDS technique comprises:
providing the chassis by injection molding;
activating at least one region of the chassis to be formed into the radiating antenna element by laser; and
coating the at least one activated region, using a conductive layer for providing the radiating antenna element.

17. The mobile device of claim 13, wherein the chassis element is adapted to receive a first display area on a first face of the mobile device and a second display area on a different face of the mobile device, wherein the first display area and the second display area are of two different display technologies.

18. The mobile device of claim 17, wherein at least one of the first display area and the second display area is always on.

19. The mobile device of claim 14, wherein the chassis element further integrates additional components comprising Light Emitting Diodes and/or at least one sensor element.

20. The mobile device of claim 19, wherein the at least sensor element comprises a touch sensor and/or a temperature sensor.

21. A computer system for integrating a radiating antenna element during the manufacturing of an electronic device comprising:
a controller module for:
providing a first chassis component of the electronic device;
providing the radiating antenna element into the first chassis; and
providing a second chassis component of the electronic device over the radiating antenna element so as to integrate the radiating antenna element between the first chassis component and the second chassis component.

22. The computer system of claim 21, wherein a chassis of the electronic device is defined by the first chassis element and the second chassis element.

23. The computer system of claim 21, wherein a chassis of the electronic device is defined by the first chassis element, the second chassis element and at least a third chassis element.

24. The computer system of claim 21, wherein the first chassis component is made of thermoplastic material containing a metal-plastic additive and wherein providing the radiating antenna element into the first chassis is performed using a Laser Direct Structuring (LDS) technique.

25. The computer system of claim 21, wherein providing the second chassis component is performed using a two-shot molding technique.

26. The computer system of claim 21, wherein the first chassis component is on the outside of the electronic device and inserting the radiating antenna element further comprises providing a connector to the radiating antenna element through the second chassis component towards an internal antenna controller of the electronic device or wherein the second chassis component is on the outside of the electronic device and inserting the radiating antenna element further comprises providing a connector to the radiating antenna element through the first chassis component towards an internal antenna controller of the electronic device.

27. The computer system of claim 21, wherein the chassis is adapted to receive a first display area on a first face of the electronic device and a second display area on a different face of the electronic device, wherein the first display area and the second display area are of two different display technologies.

28. The computer system of claim 21, wherein the chassis further integrates at least one additional component comprising Light Emitting Diodes and/or at least one sensor element.

29. The computer system of claim 27, wherein the at least sensor element comprises a touch sensor and/or a temperature sensor.

30. The computer system of claim 27, wherein at least one of the first display area and the second display area is always on.
